(19) United States
(12) Patent Application Publication
(10) Pub. No.: US 2016/0122941 A1
(43) Pub. Date: May 5, 2016

(54) CONDUCTIVE YARN, CONDUCTIVE YARN BASED PRESSURE SENSOR AND METHODS FOR PRODUCING THEM

(71) Applicant: Industry-Academic Cooperation Foundation, Yonsei University, Seoul (KR)

(72) Inventors: Taeyoon LEE, Seoul (KR); Jaehong LEE, Seoul (KR); Hyukho KWON, Seoul (KR)

(21) Appl. No.: 14/926,230

(22) Filed: Oct. 29, 2015

(30) Foreign Application Priority Data
Oct. 29, 2014 (KR) 10-2014-0148582

(51) Int. Cl. D06M 11/83; H01B 1/22; G01L 1/14

(52) U.S. Cl. CPC D06M 11/83; G01L 1/14; H01B 1/22

(57) ABSTRACT

A conductive yarn, a conductive yarn-based pressure sensor, and method for producing them are provided. A high-performance conductive yarn is produced by coating a fiber with a flexible polymer and by forming metallic nanoparticles in the flexible polymer. A high-performance conductive yarn-based pressure is produced by coating the high-performance conductive yarn with a dielectric elastomer and by arranging the conductive yarns in intersectional pattern.

### CROSS-REFERENCE TO RELATED APPLICATION(S)

This application claims the benefit under 35 U.S.C. §119(a) of a Korean patent application filed on Oct. 29, 2014 in the Korean Intellectual Property Office and assigned Serial number 10-2014-0148582, the entire disclosure of which is hereby incorporated by reference.

### TECHNICAL FIELD

The present disclosure relates to a conductive yarn, a conductive yarn-based pressure sensor, and method for producing them.

### BACKGROUND

General conductive fibers have been produced by plating metals on their surfaces, or by using conductive carbonic materials such as carbon nanotubes (CNT). However, metal plating readily could cause damages due to external environments and carbonic materials could further degrade electrical characteristics than the case of using metals.

Additionally, general fiber-based pressure sensors have been usually made in the manner of inserting pressure sensors into fibers, which have acted as a technical limit to production of high-performance pressure sensors fully based on fibers.

For that reason, there have been still industrial demands for highly flexible conductive fibers protective from damages due to external stimuli, and pressure sensors fully based on such fibers.

### SUMMARY

Aspects of the present disclosure are to address at least the above-mentioned problems and/or disadvantages and to provide at least the advantages described below. Accordingly, an aspect of the present disclosure is to provide a highly flexible, highly conductive, and high performance yarn and a method for producing the conductive yarns.

Another aspect of the present disclosure is to provide a high-performance fiber-based pressure sensor using such a conductive yarn produced according to the present disclosure, and a method for producing the pressure sensor.

In accordance with an aspect of the present disclosure, a conductive yarn may include a fiber, a flexible polymer on the fiber, and metallic nanoparticles contained in the flexible polymer.

In an embodiment, the flexible polymer may be made of stretchable rubber, the flexible polymer being capable of absorbing an alcohol and inorganic solvent.

In an embodiment, the flexible polymer may contain at least one selected from styrene-butadiene-styrene (SBS), polyurethane, and styrene-butadiene-rubber (SBR).

In an embodiment, the metallic nanoparticles may contain at least one selected from argentum (Ag), aurum (Au), cuprum (Cu), platinum (Pt), and aluminum (Au).

In an embodiment, the metallic nanoparticles may be absorbed into the flexible polymer.

In an embodiment, the conductive yarn contains the metallic nanoparticles with 50 wt % or more.

In an embodiment, the conductive yarn may have peaks from 1120 to 1140 cm⁻¹ and from 1174 to 1194 cm⁻¹ on Fourier transform infrared spectroscopy (FTIR).

In an embodiment, the conductive yarn may further include a dielectric elastomer on the flexible polymer.

In accordance with another aspect of the present disclosure, a method for producing a conductive yarn, the method may include the steps of coating a fiber with a flexible polymer, and forming metallic nanoparticles in the flexible polymer.

In an embodiment, the step of forming the metallic nanoparticles in the flexible polymer may include a step of forming argentine (Ag) nanoparticles in a styrene-butadiene-styrene (SBS) polymer.

In an embodiment, the step of coating the fiber with the flexible polymer may include a step of touching the fiber to a flexible polymer solution.

In an embodiment, the step of touching the fiber to the flexible polymer solution may include a step of flowing the polymer solution along the lengthwise direction of the fiber.

In an embodiment, the step of coating the fiber with the flexible polymer may include a step of disposing the fiber vertical to the ground and flowing a polymer solution downward from the top of the fiber along the fiber.

In an embodiment, the step of forming the metallic nanoparticles in the flexible polymer may include steps of soaking the flexible polymer in a metallic precursor solution to make metallic ions absorbed into the flexible polymer, and reducing the metallic ions, which are absorbed into the flexible polymer, to metallic nanoparticles.

In an embodiment, the step of soaking the flexible polymer in a metallic precursor solution to make metallic ions absorbed into the flexible polymer may include a step of soaking a styrene-butadiene-styrene (SBS) polymer in an AgCF₃COO solution to make Ag ions absorbed into the SBS polymer.

In an embodiment, the step of reducing the metallic ions, which are absorbed into the flexible polymer, to the metallic nanoparticles may include a step of treating the flexible polymer, into which the metallic ions are absorbed, with a reducer.

In an embodiment, the step of treating the flexible polymer, into which the metallic ions are absorbed, with the reducer may include a step of touching a hydrazine hydrate, which is the reducer, to the flexible polymer into which the metallic ions are absorbed.

In accordance with still another aspect of the present disclosure, a conductive yarn-based pressure sensor may include a conductive yarn, and a conductive material including a dielectric elastomer on the conductive yarn, wherein at least two or more of the conductive materials are arranged by intersection.

In an embodiment, the dielectric elastomer may include at least one of polymethylsiloxane (PDMS).

In accordance with further still another aspect of the present disclosure, a method for producing a conductive yarn-based pressure sensor, the method may include the steps of forming a conductive yarn through the conductive yarn producing method, coating the conductive yarn with a dielectric elastomer, and arranging forming metallic yarns, on which the dielectric elastomer is coated, in intersectional pattern.

In an embodiment, the dielectric elastomer may include polydimetylsiloxane (PDMS).

In an embodiment, the step of coating the conductive yarn with the dielectric elastomer may include a step of touching the conductive yarn to a dielectric elastomer solution.

In an embodiment, the step of touching the conductive yarn to the dielectric elastomer solution may include a step of flowing the dielectric elastomer solution along the lengthwise direction of the conductive yarn.

In an embodiment, the dielectric elastomer solution may include polydimetylsiloxane (PDMS).

In an embodiment, the step of coating the conductive yarn with the dielectric elastomer may include a step of disposing the conductive yarn vertical to the ground and flowing the dielectric elastomer solution downward from the top of the conductive yarn along the conductive yarn.

According to embodiments of the present disclosure, it may be accomplishable to produce a high-performance conductive yarn with high flexibility and high electric conductivity.

According to other embodiments of the present disclosure, it may be allowable to produce a high-performance conductive yarn-based pressure sensor which is based on fiber only.

Advantages of the present disclosure may not be restrictive to the aforementioned. Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a typical diagram illustrating configurations of a conductive yarn according to an embodiment of the present disclosure;

FIG. 2 is a flow chart showing a method for producing a conductive yarn according to an embodiment of the present disclosure;

FIG. 3 is a typical diagram illustrating a process for coating a flexible polymer of a conductive yarn or a dielectric elastomer of a conductive yarn-based pressure sensor according to an embodiment of the present disclosure;

FIG. 4 is a graphic diagram showing a variation of electrical characteristics to repetitive external stimuli applied to a conductive yarn which is produced according to embodiments of the present disclosure;

FIG. 5 is a graphic diagram showing a result of conductive Fourier-transform infrared spectroscopy (FTIR) according to embodiments of the present disclosure;

FIG. 6 is a graphic diagram showing a result of measuring the weight percentages of argentine (Ag) nanoparticles in a conductive yarn according to an embodiment of the present disclosure;

FIG. 7 is a typical diagram illustrating a conductive material of a conductive yarn-based pressure sensor according to an embodiment of the present disclosure;

FIG. 8 is a typical diagram illustrating a conductive yarn-based pressure sensor where conductive materials according to an embodiment of the present disclosure are arranged by intersection;

FIG. 9 is a flow chart showing a method for producing a conductive yarn-based pressure sensor according to an embodiment of the present disclosure;

FIGS. 10 and 11 are graphic diagrams showing results from measuring performance factors of a conductive yarn-based pressure sensor according to an embodiment of the present disclosure; and

FIGS. 12 to 14 are graphic diagrams showing reactions against various types of external stimuli to a conductive yarn-based pressure sensor according to an embodiment of the present disclosure.

Throughout the drawings, it should be noted that like reference numbers are used to depict the same or similar elements, features, and structures.

### DETAILED DESCRIPTION

Other aspects, advantages, and salient features of the present disclosure will become apparent to those skilled in the art from the following detailed embodiments. Various embodiments described herein, however, may not be intentionally confined in specific embodiments, but should be construed as including diverse modifications, equivalents, and/or alternatives. Various embodiments are merely provided to help those skilled in the art to clearly understand the technical scope of the present disclosure and the present disclosure may be only defined by the scope of the annexed claims.

Unless otherwise defined herein, all the terms used herein (including technical or scientific terms) may have the same meaning that is generally acceptable by universal technology in the related art of the present disclosure. It will be further understood that terms, which are defined in a dictionary and commonly used, may also be interpreted as is customary in the relevantly related art and/or as is same in the description of the present application. Even in the case of terminological expression with insufficient clarification, such terms may not be conceptualized or overly interpreted in formality. Therefore, the terms used in this specification are just used to describe various embodiments of the present disclosure and may not be intended to limit the scope of the present disclosure.

In the description, the terms of a singular form may also include plural forms unless otherwise specified. The terms ‘include’ and/or its diverse inflections or conjugations, for example, ‘inclusion’, ‘including’, ‘includes’, or ‘included’, as used herein, may be construed such that any one of a constitution, a component, an element, a step, an operation, and/or a device does not exclude presence or addition of one or more different constitutions, components, elements, steps, operations, and/or devices. Additionally, the term ‘comprise’ should be also interpreted as such.

According to embodiments of the present disclosure, a high-performance conductive yarn may be formed to have superior electrical characteristics and high stability against external stimuli by coating a flexible polymer on a general fiber and then forming metallic nanoparticles in the flexible polymer. Additionally, a high-performance conductive yarn-based pressure sensor may be formed by coating a dielectric elastomer on the high-performance conductive yarns and then intersecting the conductive yarns on which the dielectric elastomer is coated. Hereinafter, these features of the present disclosure will be described in more detail with reference to the following embodiments and the accompanying drawings.

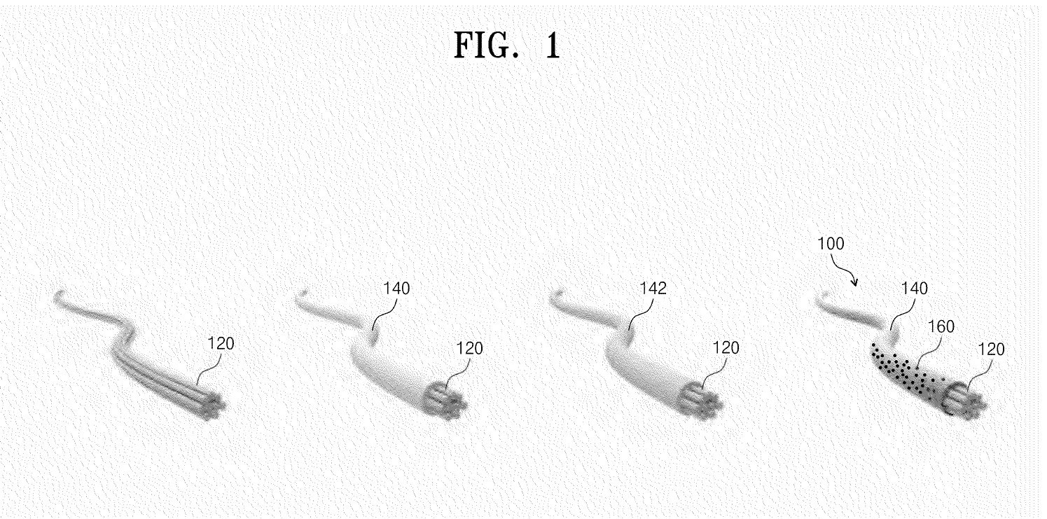

First, FIGS. 1 to 4 will be referred to describe a conductive yarn, a method of producing the conductive yarn, and functional performance of the conductive yarn.

FIG. 1 is a typical diagram illustrating configurations of a conductive yarn 100 according to an embodiment of the present disclosure.

Referring to FIG. 1, it can be seen that the conductive yarn 100 according to present disclosure may include a fiber 120, a flexible polymer 140 coated on the fiber 120, and metallic nanoparticles 160 formed in the flexible polymer 140.

The fiber 120 may be selected from general kinds of fibers without restriction. Therefore, the conductive yarn 100 may be used with a fiber suitable for need. In embodiments of the present disclosure, a kind of Kevlar may be used as the conductive yarn 100.

The flexible polymer 140 coated on the fiber 120 may be made of rubber which absorbs alcohol and an organic solvent and has stretchability. In an embodiment, the flexible polymer 140 having stretchability may shrink by 1% or more than, preferably by 10% or more than. For example, the flexible polymer 140 may contain at least one selected from styrene-butadirene-styrene (SBS), polyurethane, and styrene-butadirene rubber (SBS).

Additionally, in the case that the flexible polymer 140 is an SBS polymer, metallic nanoparticles formed in the SBS polymer may be argentum (Ag). As an SBS polymer has a high absorption rate for argentine ions, this embodiment of the present disclosure may employ such an SBS polymer and an argentine ionic solution. However, embodiments of the present disclosure may not be restrictive hereto. The flexible polymer 140, even except an SBS polymer, may be used with other kinds of polymers such as silicon-based rubber (PDMS, ecoflex), SBR polymer, vynylidene fluoride-co-hexafluoroprophylene, and so on. The metallic nanoparticles 160 may also not be restrictive to argentine nanoparticles, and may be made of another metal such as aurum (Au), Cuprum (Cu), platinum (Pt), or aluminum (Al). The metal nanoparticle may be a metallic particle whose diameter is sized equal to or larger than 1 nm and smaller than 1000 nm, preferably between 50 nm and 200 nm.

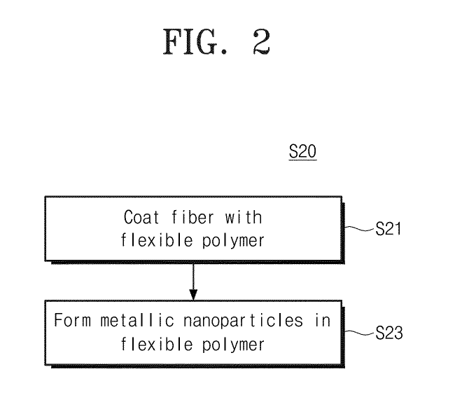

FIG. 2 is a flow chart S20 showing a method for producing a conductive yarn according to an embodiment of the present disclosure.

Referring to FIG. 2, a method of producing a conductive yarn may include a step of coating a flexible polymer on a fiber (S21), and a step of forming metallic nanoparticles in the flexible polymer (S23).

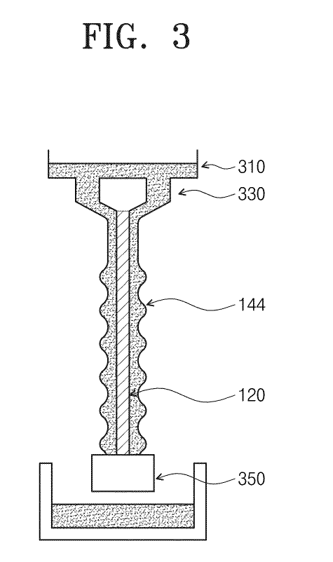

In an embodiment, the step S21 of coating a flexible polymer on a fiber may include a step of touching the fiber to a flexible polymer solution. The fiber may include a plurality of fibers. As an embodiment, the step of touching the fiber to a flexible polymer solution may flow the polymer solution along the lengthwise direction of the fiber. In another embodiment, the step S21 of coating a flexible polymer on a fiber may proceed to flow down a polymer solution along the fiber from the top of the fiber after disposing the fiber vertical to the ground (this will be hereinafter described with FIG. 3).

In an embodiment, the step S23 of forming metallic nanoparticles in the flexible polymer may include steps of soaking the flexible polymer in a metallic precursor solution to make the metallic precursors absorbed into the flexible polymer, and reducing the metallic precursors from the inside of the flexible polymer to the metallic nanoparticles. Additionally, by repeating the steps of soaking the flexible polymer in a metallic precursor solution to make the metallic precursors absorbed into the flexible polymer and reducing the metallic precursors from the inside of the flexible polymer to the metallic nanoparticles, it may be accomplishable to further improve electrical characteristics. As an embodiment, the step of soaking the flexible polymer in a metallic precursor solution to make the metallic precursors absorbed into the flexible polymer may dip the flexible polymer in a solution, in which the metallic precursors are much dissolved, to make the metallic precursors absorbed into the flexible polymer. As an embodiment, the step of reducing the metallic precursors from the inside of the flexible polymer to the metallic nanoparticles may include a step of treating the flexible polymer, into which the metallic precursors are absorbed, with a reducer. For example, by touching the flexible polymer to hydrazine hydrate which is a kind of reducer, the metallic precursors may be reduced to the metallic nanoparticles. However, the reducer may not be restrictive hereto in kind.

FIG. 3 is a typical diagram illustrating a process for coating a flexible polymer of a conductive yarn or a dielectric elastomer of a conductive yarn-based pressure sensor according to an embodiment of the present disclosure.

As illustrated in FIG. 3, the process for coating a flexible polymer or a dielectric elastomer may be performed to suspend a weight 350 from a fiber 120 or a conductive yarn 100 in the vertical direction to the ground. Then, by flowing a flexible polymer solution 144 or a dielectric elastomer solution 144 in a specific rate toward the fiber 120 or the conductive yarn 100 from a tank 310, which contains the flexible polymer solution 144 or the dielectric elastomer solution 144, via a nozzle 330, a flexible polymer 140 or a dielectric elastomer 500 may be uniformly coated on the fiber 120 or the conductive yarn 100.

### [Embodiment] Production of Conductive Yarn

A general Kevlar fiber is disposed vertical to the ground and a weight is fixedly suspended from the Kevlar fiber. An SBS polymer solution is prepared with 5% concentration by dissolving an SBS material in a solvent which is mixed with tetrahydrofuran (THF) and dimethylformamide (DMF) in the weight ratio of 3:1. This SBS solution is flown along the Kevlar fiber in a specific rate and thereby uniformly coated on the Kevlar fiber after 1 minute or thereabout. Afterward, an argentine (Ag) precursor solution (a solution in which argentine ions are much dissolved) is prepared by dissolving AgCF₃COO with 15% concentration in an ethanol as a solvent. The Kevlar fiber coated with the SBS polymer is soaked in the argentine precursor solution for 30 minutes or thereabout to make the argentine ions sufficiently absorbed into the SBS polymer, and thereafter drawn out of the argentine precursor solution and dried. Then, hydrazine hydrate is dropped down to the SBS polymer much containing the argentine ions to reduce the argentine ions and washed away by water to produce a high-performance conductive yarn containing argentine nanoparticles.

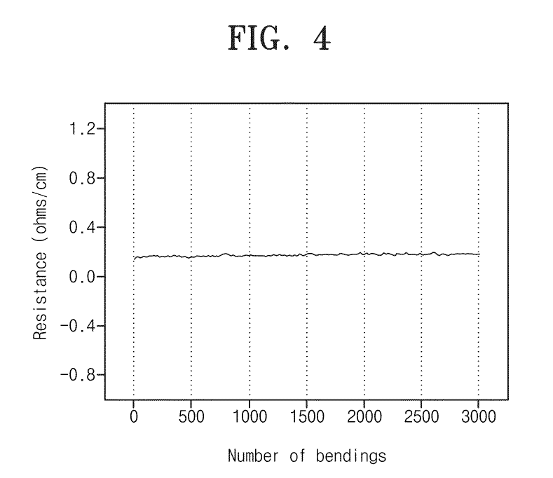

FIG. 4 is a graphic diagram showing a variation of electrical characteristics to repetitive external stimuli applied to a conductive yarn which is produced according to embodiments of the present disclosure.

Referring to FIG. 4, a conductive yarn produced according to embodiments of the present disclosure may result in high stability because there is no fluctuation of electrical characteristics even to repetitive external stimuli. It can be seen from FIG. 4 that a conductive yarn produced according to embodiments of the present disclosure is stabilized in electrical characteristics even against 3000 times of 180°-folding stimuli.

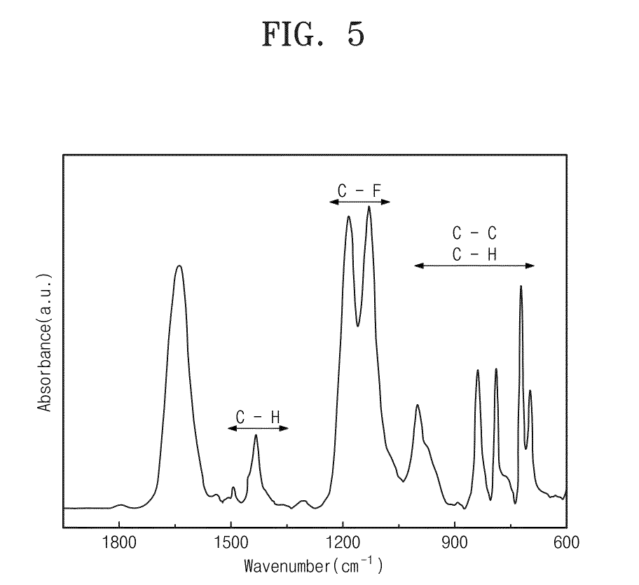

FIG. 5 is a graphic diagram showing a result of conductive Fourier-transform infrared spectroscopy (FTIR) according to embodiments of the present disclosure.

It can be seen from FIG. 5 that a conductive yarn according to embodiments of the present disclosure has peaks at the regions of wave numbers which are ranged from 1120 to 1140 cm⁻¹ and from 1174 to 1184 cm⁻¹. In more detail, the peaks may be generated when the wave number reaches 1130 and 1184 cm⁻¹.

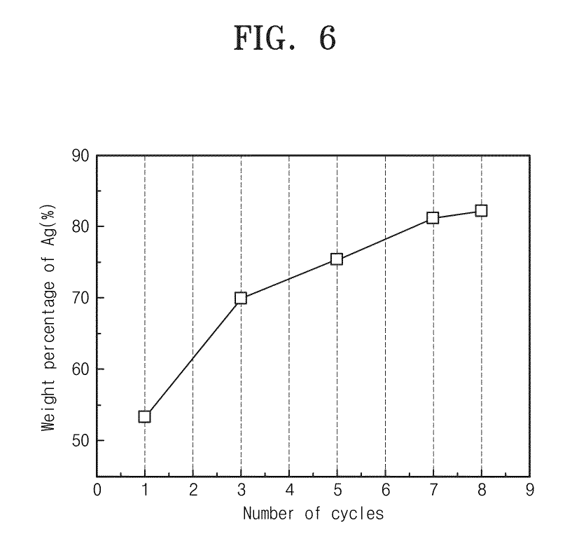

FIG. 6 is a graphic diagram showing a result of measuring the weight percentages (wt %) of argentine (Ag) nanoparticles in a conductive yarn according to an embodiment of the present disclosure.

The number of cycles shown in FIG. 6 means the number of repeating a unit process according to embodiments of the present disclosure. Referring to FIG. 6, it can be seen that a conductive yarn may be formed with high-content argentine nanoparticles of 50 wt % even after one-cycle process according to an embodiment of the present disclosure. In detail, for a conductive yarn according to the embodiment, its content of argentine nanoparticles is 53.3% and increases up to 82.3% after repetition of 8 cycles.

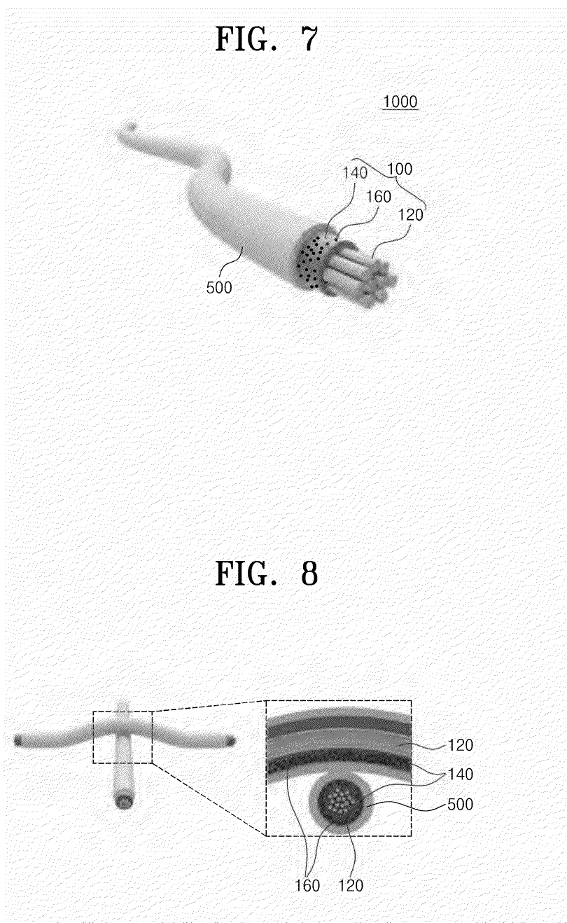

Now, FIGS. 7 to 9 will be referred to describe a conductive yarn-based pressure sensor and a method for producing the pressure sensor, employing a conductive yarn according to the present disclosure and a method for producing the conductive yarn.

FIG. 7 is a typical diagram illustrating a conductive material 1000 of a conductive yarn-based pressure sensor according to an embodiment of the present disclosure.

As illustrated in FIG. 7, the conductive material 1000 of a conductive yarn-based pressure sensor according to an embodiment of the present disclosure may include a conductive yarn 100 having a fiber 120, a flexible polymer 140 coated on the fiber 120, and metallic nanoparticles 160 formed in the flexible polymer 140, and a dielectric elastomer 500 coated on the conductive yarn 100. The dielectric elastomer 500 may include polydimethylsiloxane (PDMS) or ecoflex.

FIG. 8 is a typical diagram illustrating a conductive yarn-based pressure sensor where conductive materials according to an embodiment of the present disclosure are arranged by intersection.

Referring to FIG. 8, a conductive yarn-based pressure sensor according to an embodiment of the present disclosure may be formed with intersectional arrangement of conductive materials (see FIG. 7) which contain a dielectric elastomer 500 coated on a conductive yarn 100. As shown in the explosive illustration of FIG. 8, a conductive yarn-based pressure sensor according to the present disclosure may be equipped with a capacitor which has a dielectric of a dielectric elastomer on at least two of conductive materials. Accordingly, in the case of applying pressure to the pressure sensor, the capacitance increases as the dielectric elastomer decreases in thickness and the two conductive materials increase in contact area of them. Additionally, a conductive yarn-based pressure sensor according to the present disclosure may be further widened in contact area between the two conductive materials, when pressure is applied thereto, because of using a conductive yarn 100 coated with a flexible polymer 140. Accordingly, it may be allowable to implement a conductive yarn-based pressure sensor which is more improved in capacitance. Consequently, a high-performance conductive yarn-based pressure sensor may be produced based on the principle as such.

A method for producing a conductive yarn-based pressure sensor will be described hereinbelow.

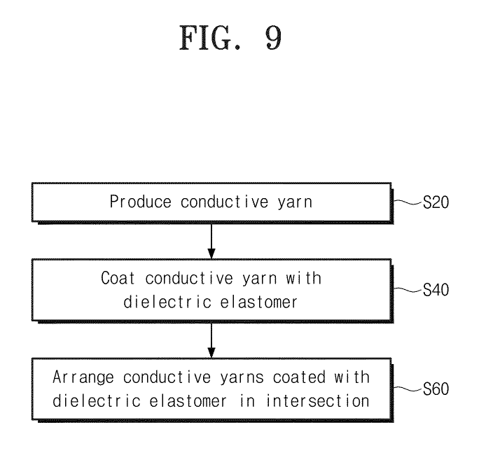

FIG. 9 is a flow chart showing a method for producing a conductive yarn-based pressure sensor according to an embodiment of the present disclosure.

Referring to FIG. 9, a method for a conductive yarn-based pressure sensor according to an embodiment of the present disclosure may include the steps of producing a conductive yarn under a conductive-yarn manufacturing process (S20), coating the conductive yarn with a dielectric elastomer (S40), and arranging at least two or more of the conductive yarns, which are coated with the dielectric elastomer, by intersection (S60).

In an embodiment, the step S20 of producing the conductive yarn may be executed by the process aforementioned in conjunction with FIG. 2 (refer to the description of FIG. 2).

In an embodiment, the step S40 of coating the conductive yarn with a dielectric elastomer may include a step of touching the conductive yarn to a dielectric elastomer solution. In an embodiment, the step of touching the conductive yarn to a dielectric elastomer solution may be performed by flowing the dielectric elastomer solution along the lengthwise direction of the conductive yarn to make the conductive yarn meet the dielectric elastomer solution. In another embodiment, the step S40 of coating the conductive yarn with a dielectric elastomer may be performed by disposing the conductive yarn in the vertical direction of the ground and then flowing the dielectric elastomer solution downward from the top of the conductive yarn along the conductive yarn to uniformly coat the conductive yarn with the dielectric elastomer (see FIG. 3). The dielectric elastomer may contain PDMS or ecoflex. Especially, PDMS has been improper in uniform coating due to its high elasticity and rich viscosity, but it becomes to be uniformly coated thereon through the coating process (see FIG. 3) according to an embodiment of the present disclosure.

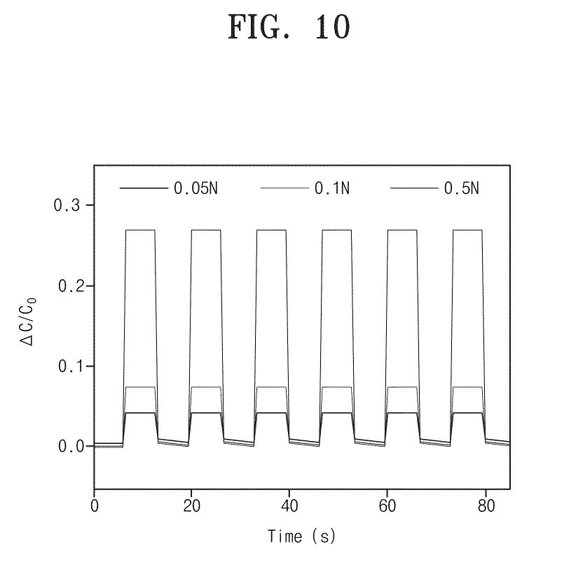

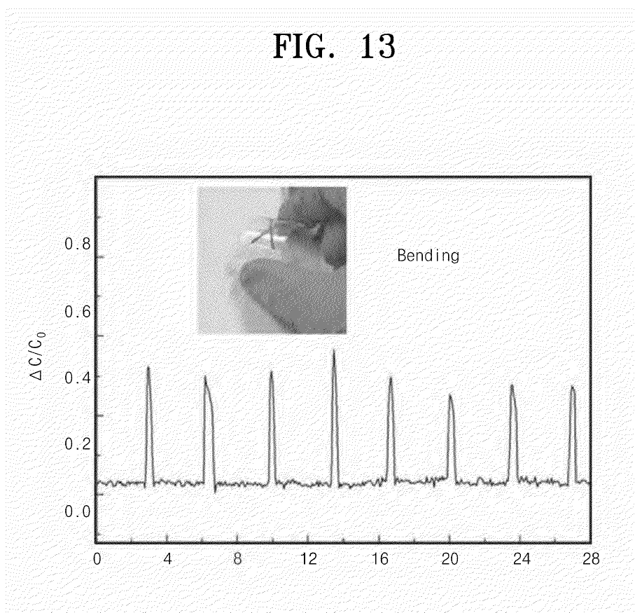

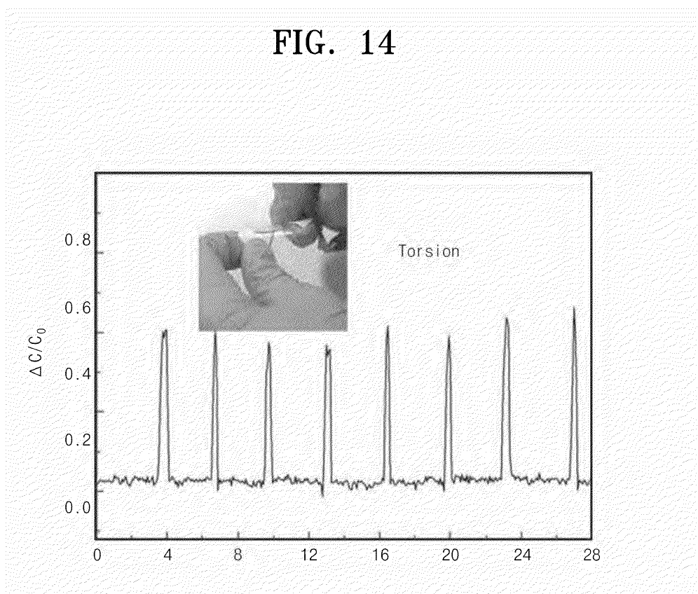

Now, the performance of a conductive yarn-based pressure sensor according to embodiments of the present disclosure will be considered in conjunction with FIGS. 10 and 11, and FIGS. 12 to 14.

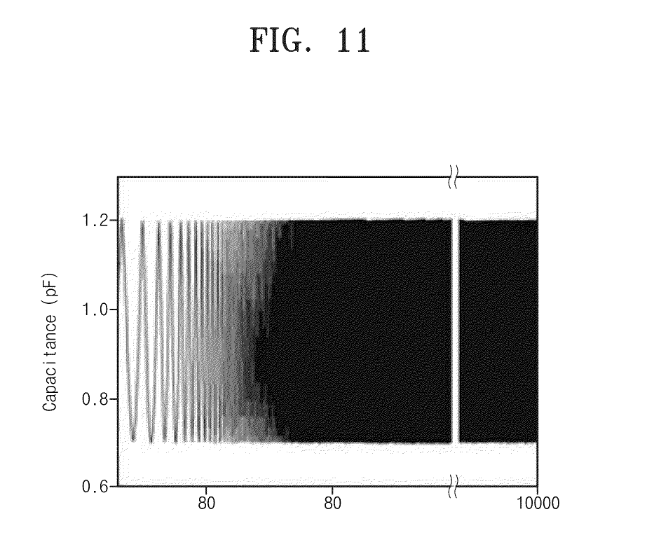

FIGS. 10 and 11 are graphic diagrams showing results from measuring performance factors of a conductive yarn-based pressure sensor according to an embodiment of the present disclosure.

FIG. 10 graphically shows variations of capacitance of a conductive yarn-based pressure sensor according to embodiments of the present disclosure when diverse Newtons of forces are applied to the pressure sensor. As shown in FIG. 10, a conductive yarn-based pressure sensor according to embodiments of the present disclosure responds to diverse Newtons of forces and, for example, positively responds to a small force of 0.05 N.

FIG. 11 graphically shows a variation of capacitance of a conductive yarn-based pressure sensor according to embodiments of the present disclosure when pressure is repetitively applied to the pressure sensor. As shown in FIG. 11, a conductive yarn-based pressure sensor according to embodiments of the present disclosure is uniformly stabilized without a decrease of variation in capacitance even when pressure is repetitively applied thereto. In other words, it can be seen from the result shown in FIG. 11 that a conductive yarn-based pressure sensor may be highly stabilized even against repetitive pressure.

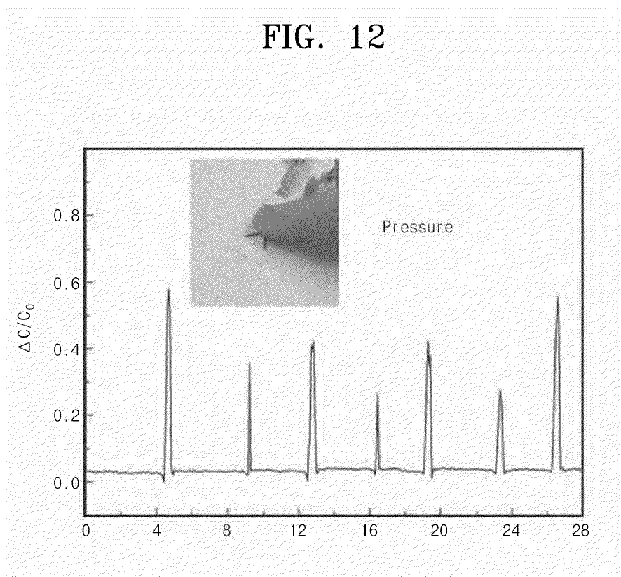

FIGS. 12 to 14 are graphic diagrams showing reactions against various types of external stimuli to a conductive yarn-based pressure sensor according to an embodiment of the present disclosure.

FIGS. 12 to 14 graphically show reactions of a conductive yarn-based pressure sensor according to an embodiment of the present disclosure when pressure, bending, and torsion are applied thereto, respectively. From FIGS. 12 to 14, it can be seen that a conductive yarn-based pressure sensor according to embodiments of the present disclosure may positively vary its capacitance even to various types of external stimuli.

Consequently, from the graphic diagrams showing experimental results for evaluating the performance of a conductive yarn, a method for producing the conductive yarn, a conductive yarn-based pressure sensor, and a method for producing the conductive yarn-based pressure sensor, it can be verified that the conductive yarn and the conductive yarn-based pressure sensor may be characterized in superior performance

While embodiments of the present disclosure have been shown and described with reference to the accompanying drawings thereof, it will be understood by those skilled in the art that various changes and modifications in form and details may be made therein without departing from the spirit and scope of the present disclosure as defined by the appended claims and their equivalents. For example, it may be allowable to achieve the desired results although the embodiments of the present disclosure are preformed in dispersed forms with the elements disclosed on the embodiments of the present disclosure, or in combinational forms with the elements. Therefore, the technical scope of the present disclosure should be almost defined by the inventive concept of the appended claims, but without literally restrictive to the claims, and should be construed as including other implementations, other embodiments, and equivalents of the appended claims.

What is claimed is:

1. A conductive yarn comprising:
a fiber;
a flexible polymer on the fiber; and
metallic nanoparticles contained in the flexible polymer.

2. The conductive yarn of claim 1, wherein the flexible polymer is made of stretchable rubber, the flexible polymer being capable of absorbing an alcohol and inorganic solvent.

3. The conductive yarn of claim 2, wherein the flexible polymer contains at least one selected from styrene-butadiene-styrene (SBS), polyurethane, and styrene-butadiene-rubber (SBR).

4. The conductive yarn of claim 1, wherein the metallic nanoparticles contain at least one selected from argentum (Ag), aurum (Au), cuprum (Cu), platinum (Pt), and aluminum (Al).

5. The conductive yarn of claim 1, wherein the metallic nanoparticles are absorbed into the flexible polymer.

6. The conductive yarn of claim 1, wherein the flexible polymer is styrene-butadiene-styrene (SBS), and
wherein the metallic nanoparticles are made of argentum (Ag).

7. The conductive yarn of claim 1, wherein the conductive yarn contains the metallic nanoparticles with 50 wt % or more.

8. The conductive yarn of claim 1, wherein the conductive yarn has peaks from 1120 to 1140 cm⁻¹ and from 1174 to 1194 cm⁻¹ on Fourier transform infrared spectroscopy (FTIR).

9. The conductive yarn of claim 1, further comprising a dielectric elastomer on the flexible polymer.

10. A method for producing a conductive yarn, the method comprising:
coating a yarn with a flexible polymer;
soaking the flexible polymer in a metallic precursor solution to make metallic ions absorbed into the flexible polymer; and
reducing the metallic ions to metallic nanoparticles.

11. The method of claim 10, wherein the soaking of the flexible polymer in the metallic precursor solution to make the metallic ions absorbed into the flexible polymer comprises:
soaking a styrene-butadiene-styrene (SBS) polymer in an AgCF₃COO solution to make Ag ions absorbed into the SBS polymer.

12. The method of claim 10, wherein the coating of the yarn on the flexible polymer comprises:
disposing the yarn vertical to the ground and flowing a flexible polymer solution downward from the top of the yarn along the yarn.

13. The method of claim 10, wherein the reducing of the metallic ions to the metallic nanoparticles comprises:
treating the flexible polymer with a reducer.

14. The method of claim 13, wherein the treating of the flexible polymer with the reducer comprises:
touching a hydrazine hydrate, which is the reducer, to the flexible polymer into which the metallic ions are absorbed.

15. A conductive yarn-based pressure sensor comprising:
a conductive yarn; and
a conductive material including a dielectric elastomer on the conductive yarn,
wherein at least two or more of the conductive material are arranged by intersection, and
wherein the conductive yarn comprises:
a fiber;
a flexible polymer on the fiber; and
metallic nanoparticles contained in the flexible polymer.

16. The conductive yarn-based pressure sensor of claim 15, wherein the dielectric elastomer comprises at least one selected from polymethylsiloxane (PDMS) and ecoflex.

17. The conductive yarn-based pressure sensor of claim 15, wherein the flexible polymer is made of stretchable rubber, the flexible polymer being capable of absorbing an alcohol and inorganic solvent.

18. The conductive yarn-based pressure sensor of claim 17, wherein the flexible polymer contains at least one selected from styrene-butadiene-styrene (SBS), polyurethane, and styrene-butadiene-rubber (SBR).

19. The conductive yarn-based pressure sensor of claim 15, the conductive yarn contains the metallic nanoparticles with 50 wt % or more.

20. The conductive yarn-based pressure sensor of claim 15, wherein the conductive yarn has peaks from 1120 to 1140 cm⁻¹ and from 1174 to 1194 cm⁻¹ on Fourier transform infrared spectroscopy (FTIR).
